(19) United States
(12) Patent Application Publication
(10) Pub. No.: US 2020/0378774 A1
(43) Pub. Date: Dec. 3, 2020

(54) METHOD FOR ALLOCATING SHAREABLE VEHICLES IN PRESET AREAS AND ELECTRONIC DEVICE EMPLOYING THE METHOD

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventors: CUI-FENG ZHAO, Zhengzhou (CN); YONG-KUN ZHANG, Zhengzhou (CN)

(21) Appl. No.: 16/540,331

(22) Filed: Aug. 14, 2019

(30) Foreign Application Priority Data
May 31, 2019 (CN) 201910471904.5

(51) Int. Cl. G01C 21/34; G06K 9/00; G05D 1/02; G01C 21/36

(52) U.S. Cl. CPC G01C 21/3438; G01C 21/3605; G05D 1/0287; G06K 9/00221

(57) ABSTRACT

A method for allocating shareable vehicles such as bicycles and electric cars in given and preset areas collects facial images from local bus and coach passengers. The route of the bus is communicated and determinations are made as to whether the passengers are travelling short distances within the bus route. The number of shareable vehicles allocated to the preset area is determined according to a predetermined ratio, to avoid oversupply or undersupply by the operator/owner of such vehicles in each preset area.

### FIELD

The subject matter herein generally relates to public transportation technology.

### BACKGROUND

Many vehicles such as bicycles and electric cars are shareable. The operators of the shareable vehicles may leave the vehicles on streets randomly which result in a shortage of shareable vehicles in streets with a large number of users. On the other hand, shareable vehicles in streets with fewer users may not be fully utilized. Such variations in usage rates of shareable vehicles may cause extra labor and loss of profit for the operators who manage the shareable vehicles, and is inconvenient for the customers who cannot find available vehicles.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device.

FIG. 2 illustrates a flowchart of one embodiment of a method for allocating shareable vehicles applied in the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprises” means “including, but not necessarily limited to”; it specifically indicates open-ended inclusion or membership in a so-described combination, group, series, and the like.

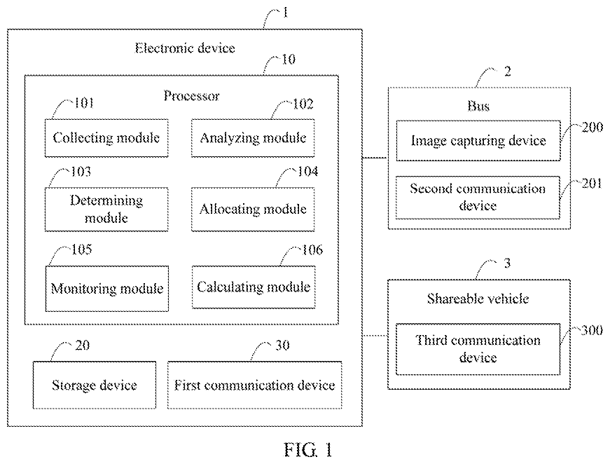

FIG. 1 shows one embodiment of an electronic device (electronic device 1). Depending on the embodiment, the electronic device 1 can include, but is not limited to, at least one processor 10, a storage device 20, and a first communication device 30. The storage device 20, at least one processor 10, and the first communication device 30 communicate with each other through a system bus.

In at least one embodiment, the storage device 20 can be an internal storage device, such as a flash memory, a random access memory (RAM) for temporary storage of parameters, and/or a read-only memory (ROM) for permanent storage of parameters. The storage device 20 can also be an external storage device, such as an external hard disk, a storage card, or a data storage medium. The at least one processor 10 can be a central processing unit (CPU), a microprocessor, or other data processor chip that performs functions of the electronic device 1.

In at least one embodiment, the first communication device 30 is a wireless communication device, which can establish a remote communication connection with a second communication device 201 of a plurality of buses 2 and a third communication device 300 of a plurality of shareable vehicles 3.

In at least one embodiment, the electronic device 1 is a server, which can automatically configure shareable vehicles 3 for a plurality of preset areas of a city. FIG. 1 illustrates only one example of the electronic device 1, other examples can comprise more or fewer components than those shown in the embodiment, or have a different configuration of the various components. For example, the electronic device 1 can further include a circuit system, input/output interface, a battery, an operating system, and so on.

In at least one embodiment, the processor 10 as shown in FIG. 1 can include, but is not limited to, a collecting module 101, an analyzing module 102, a determining module 103, an allocating module 104, a monitoring module 105, and a calculating module 106. The modules 101-106 can comprise computerized instructions in the form of one or more computer-readable programs that can be stored in a non-transitory computer-readable medium, for example in the storage device 20, and executed by the processor 10 of the electronic device 1.

In at least one embodiment, the collecting module 101 can collect facial images of at least one passenger by an image capturing device 200 of at least one bus 2.

In at least one embodiment, the electronic device 1 can send a control command to a second communication device 201 of the at least one bus 2 when the number and locations of the shareable vehicles 3 in a predetermined area need to be determined and configured. The second communication device 201 can control the image capturing device 200 to capture facial images of the passengers on board or coming aboard, after the control command is received. The image capturing device 200 is a camera. Preferably, each bus 2 is provided with an image capturing device 200 at a position of the front door and the rear or middle door. For example, one image capturing device 200 on the bus 2 can face the front door, and another image capturing device 200 on the bus 2 can face the inside of the bus 2 to facilitate capturing images of faces of passengers when the passengers get on or off. The second communication device 201 is further configured to transmit a plurality of images captured by the image capturing device 200 to the electronic device 1. The electronic device 1 can store the images in the storage device 20.

In at least one embodiment, the analyzing module 102 can obtain a travel route of each passenger according to a route of the bus 2 and facial images of each passenger.

In at least one embodiment, the analyzing module 102 can filter out images captured by the image capturing device 200 which do not show a face according to the face Haar feature by using the Adaboost machine learning algorithm. The analyzing module 102 can set the facial images of different passengers, captured by the image capturing device 200 for the first time, as initial samples of passengers. The analyzing module 102 can store the initial samples in the storage device 20. The analyzing module 102 can set the facial images captured subsequently as a basis for determining the travel route of each passenger.

In at least one embodiment, the analyzing module 102 further can determine whether facial images are of passengers getting on or off the vehicle (bus 2) by analyzing the facial images. Then the analyzing module 102 can determine a current travel route of the passenger according to the determined facial images and the driving route of the bus 2. For example, the collecting module 101 can collect a first facial image to determine that a passenger is getting on the bus 2 at a first bus stop A. The collecting module 101 can collect a second facial image to determine that such passenger is getting off the bus 2 at a second bus stop B. Then the analyzing module 102 can determine the travel route of the passenger according to the first facial image and the second facial image, and the driving route from the bus stop A to the bus stop B.

In at least one embodiment, the analyzing module 102 further can analyze the travel routes of each passenger in a preset period. In this embodiment, the preset period can be one week. In other embodiments, the preset period may also be one month.

In at least one embodiment, the determining module 103 can determine whether passengers are travelling short distances in the preset area according to travel routes of the passengers.

In at least one embodiment, the preset area can be a bus stop. In other embodiments, the preset area may also be a street, a cell, or an administrative area.

In at least one embodiment, the determining module 103 can determine whether a distance travelled by each passenger is less than or equal to a predetermined distance according to the travel route of each passenger. The predetermined distance can be five kilometers. When the travel distance of each passenger is less than or equal to the predetermined distance, the determining module 103 can determine that the passengers are travelling with short-distances in the preset area.

In at least one embodiment, the allocating module 104 can allocate and distribute the number of the shareable vehicles 3 in the preset area according to a predetermined ratio. The predetermined ratio is the result of dividing a total number of passengers travelling such short distances in the preset area by the number of the shareable vehicles 3.

In at least one embodiment, the allocating module 104 can determine the total number of passengers needing to travel short distances in the preset area based on the determining module 103, and allocate the number of the shareable vehicles 3 in the preset area according to the predetermined ratio. For example, the predetermined ratio can be 4:1. When the total number of short-distance passengers in the preset area is two hundred, the allocating module 104 can allocate fifty shareable vehicles 3 in the preset area according to the predetermined ratio. In other embodiments, values can be set according to other requirements.

In at least one embodiment, the monitoring module 105 can monitor usage of the shareable vehicles 3 in the preset area.

In at least one embodiment, the monitoring module 105 can monitor the usage of the shareable vehicles 3 by the third communication device 300. When the third communication device 300 has established communication connection with user equipment, the monitoring module 105 can determine that the shareable vehicle 3 was used by the user. The third communication device 300 of each shareable vehicle can return usage information to the monitoring module 105.

In at least one embodiment, the allocating module 104 can reduce the number of the shareable vehicles 3 allocated to a preset area when all or some of the shareable vehicles 3 are redundant and unused in the preset area. When the number of the shareable vehicle is greater than a first predetermined number in the preset area, the allocating module 104 can determine that the shareable vehicle is redundant in the preset area. For example, the first predetermined number can be one hundred.

In at least one embodiment, when the third communication device 300 of the shareable vehicle 3 does not return usage information to the monitoring module 105, the monitoring module 105 can determine that the shareable vehicle 3 in the preset area is not being used and therefore redundant, and the allocating module 104 can reduce a preset number of the shareable vehicles 3 allocated in the preset area. The preset number of the shareable vehicles 3 can be ten.

In at least one embodiment, the allocating module 104 further can increase a preset number of shareable vehicles 3 in the preset area when the number of shareable vehicles 3 in the preset area is insufficient. When the number of the shareable vehicle 3 is less than a second predetermined number in the preset area, the allocating module 104 can determine that the shareable vehicle 3 is insufficient in the preset area. For example, the second predetermined number can be twenty. The first predetermined number and the second predetermined number are varying with a size of the preset area. For example, the first predetermined number is proportional to the size of the preset area.

In at least one embodiment, the monitoring module 105 further can detect that a request of a user for using a shareable vehicle 3 is not responded to. When the electronic device 1 does not respond to a request, the allocating module 104 can determine that the number of shareable vehicles 3 in the preset area is insufficient, and increase the preset number in the preset area.

In at least one embodiment, the calculating module 106 can calculate a ratio α between the total number of short-distance passengers and the actual number of passengers using the shareable vehicles 3 according to the number of shareable vehicles 3 that the allocating module 104 has increased or reduced.

In at least one embodiment, the determining module 103 can determine the number of shareable vehicles 3 which need to be allocated in the preset area. The number of shareable vehicles is calculated according to formula: y=x/α, where x is the total number of short-distance passengers. The allocating module 104 can allocate the number of shareable vehicles 3 needing to be allocated in the preset area according to the formula.

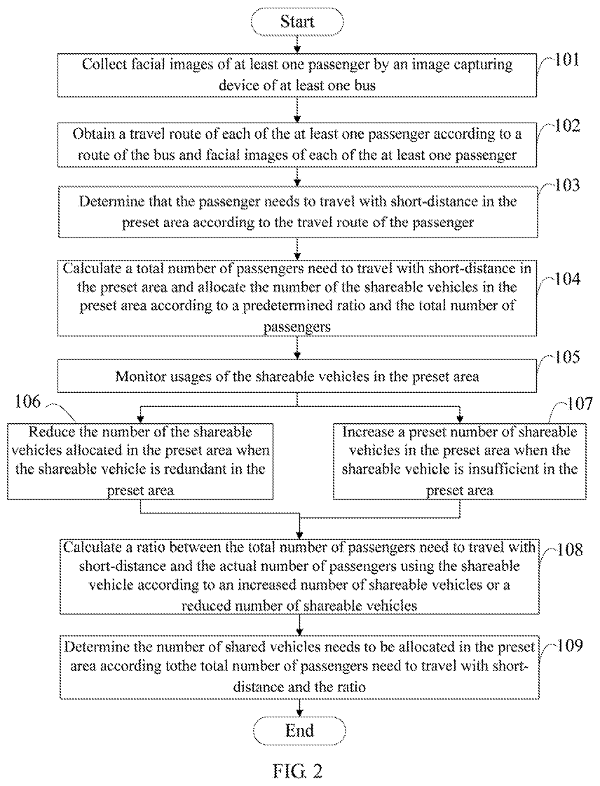

FIG. 2 illustrates a flowchart of one embodiment of a method for allocating shareable vehicles applied in the electronic device of FIG. 1. In an example embodiment, the method is performed by execution of computer-readable software program codes or instructions by the processor 10 of the electronic device 1.

Referring to FIG. 2, the method is provided by way of example, as there are a variety of ways to carry out the method. The method described below can be carried out using the configurations illustrated in FIG. 1, for example, and various elements of these figures are referenced in explaining method. Each block shown in FIG. 2 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block 101.

At block 101, the collecting module 101 can collect facial images of at least one passenger by an image capturing device 200 of at least one bus 2.

At block 102, the analyzing module 102 can obtain a travel route of each of the at least one passenger according to a route of the bus 2 and facial images of each of the at least one passenger.

At block 103, the determining module 103 can determine that the passenger needs to travel with short-distance in the preset area according to the travel route of the passenger.

At block 104, the allocating module 104 can calculate a total number of passengers need to travel with short-distance in the preset area and allocate the number of the shareable vehicles in the preset area according to a predetermined ratio and the total number of passengers. The number of the shareable vehicles in the preset area needing to be allocated is equal to a result that by dividing a total number of passengers needing to travel with short-distance in the preset area by the predetermined ratio.

At block 105, the monitoring module 105 can monitor usages of the shareable vehicles 3 in the preset area.

At block 106, the allocating module 104 can reduce the number of the shareable vehicles 3 allocated in the preset area when the shareable vehicle 3 is redundant in the preset area.

At block 107, the allocating module 104 further can increase a preset number of shareable vehicles 3 in the preset area when the shareable vehicle 3 is insufficient in the preset area.

At block 108, the calculating module 106 can calculate a ratio α between the total number of passengers needing to travel with short-distance and the actual number of passengers using the shareable vehicle 3 according to an increased number of shareable vehicles or a reduced number of shareable vehicles.

At block 109, the determining module 103 can determine the number of shareable vehicles 3 needing to be allocated in the preset area according to formula: y=x/α, x is the total number of passengers needing to travel with short-distance.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device communicating with at least one bus, the electronic device comprising:
a storage device; and
at least one processor, wherein
the storage device storing one or more programs that, when executed by the at least one processor, cause the at least one processor to:
collect facial images of at least one passenger by an image capturing device of the at least one bus;
obtain a travel route of each of the at least one passenger according to a route of the at least one bus and facial images of each of the at least one passenger;
determine whether a passenger needs to travel with short-distance in the preset area according to the travel route of each of the at least one passenger;
calculate a total number of passengers when the passengers need to travel with short-distance in the preset area; and
allocate a number of shareable vehicles in the preset area according to a predetermined ratio and the total number of passengers needing to travel with short-distance in the preset area.

2. The electronic device according to claim 1, wherein the at least one processor is further caused to:
monitor usages of the shareable vehicles in the preset area;
reduce the number of the shareable vehicles allocated in the preset area when the number of the shareable vehicle is greater than a first predetermined number in the preset area; and
increase a preset number of shareable vehicles in the preset area when the number of the shareable vehicle is less than a second predetermined number in the preset area.

3. The electronic device according to claim 2, wherein the at least one processor is further caused to:
calculate a ratio α between the total number of passengers needing to travel with short-distance and the actual number of passengers using the shareable vehicle according to an increased number of shareable vehicles or a reduced number of shareable vehicles;
calculate the number of shareable vehicles needing to be allocated in the preset area according to formula: y=x/α, wherein x is the total number of passengers needing to travel with short-distance; and
allocate the number of shareable vehicles in the preset area according to the calculated number of shareable vehicles.

4. The electronic device according to claim 1, wherein the at least one processor is further caused to:
determine whether a travel distance of the passenger is less than or equal to a predetermined distance according to the travel route of each of the at least one passenger;
determine that the passenger needs to travel with short-distance in the preset area when the travel distance of the passenger is less than or equal to the predetermined distance.

5. The electronic device according to claim 1, wherein the at least one processor is further caused to:
collect at least one first facial image of the at least one passenger when the at least one passenger is getting on the bus at a first bus stop;
collect at least one second facial image of the at least one passenger when the at least one passenger is getting off the bus at a second bus stop; and
determine the travel route of each of the at least one passenger according to the first facial image and the second facial image, and a route from the first bus stop to the second bus stop.

6. A shareable vehicle allocating method applicable in an electronic device, the electronic device communicating with at least one bus, the method comprising:
collecting facial images of at least one passenger by an image capturing device of the at least one bus;
obtaining a travel route of each of the at least one passenger according to a route of each of the at least one bus and facial images of each of the at least one passenger;
determining whether a passenger needs to travel with short-distance in the preset area according to the travel route of each of the at least one passenger;
calculating a total number of passengers when the passengers need to travel with short-distance in the preset area; and
allocating a number of shareable vehicles in the preset area according to a predetermined ratio and the total number of passengers need to travel with short-distance in the preset area.

7. The method according to claim 6, wherein the method further comprises:
monitoring usages of the shareable vehicles in the preset area;
reducing the number of the shareable vehicles allocated in the preset area when the number of the shareable vehicles is greater than a first predetermined number in the preset area; and
increasing a preset number of shareable vehicles in the preset area when the number of the shareable vehicles is less than a second predetermined number in the preset area.

8. The method according to claim 7, wherein the method further comprises:
calculating a ratio α between the total number of passengers needing to travel with short-distance and the actual number of passengers using the shareable vehicles according to an increased number of shareable vehicles or a reduced number of shareable vehicles;
calculating the number of shareable vehicles needing to be allocated in the preset area according to formula: y=x/α, wherein x is the total number of passengers needing to travel with short-distance; and
allocating the number of shareable vehicles in the preset area according to the calculated number of shareable vehicles.

9. The method according to claim 6, wherein the method further comprises:
determining whether a travel distance of the passenger is less than or equal to a predetermined distance according to the travel route of each of the at least one passenger;
determining that the passenger needs to travel with short-distance in the preset area when the travel distance of the passenger is less than or equal to the predetermined distance.

10. The method according to claim 6, wherein the method further comprises:
collecting at least one first facial image of the at least one passenger when the at least one passenger is getting on the bus at a first bus stop;
collecting at least one second facial image of the at least one passenger when the at least one passenger is getting off the bus at a second bus stop; and
determining the travel route of each of the at least one passenger according to the first facial image and the second facial image, and a route from the first bus stop to the second bus stop.

11. A non-transitory storage medium having stored thereon instructions that, when executed by a processor of an electronic device, causes the processor to perform a shareable vehicle allocating method, the electronic device communicating with at least one bus, the method comprising:
collecting facial images of at least one passenger by an image capturing device of the at least one bus;
obtaining a travel route of each of the at least one passenger according to a route of each of the at least one bus and facial images of each of the at least one passenger;
determining whether a passenger needs to travel with short-distance in the preset area according to the travel route of each of the at least one passenger;
calculating a total number of passengers when the passengers need to travel with short-distance in the preset area; and
allocating a number of shareable vehicles in the preset area according to a predetermined ratio and the total number of passengers needing to travel with short-distance in the preset area.

12. The non-transitory storage medium according to claim 11, wherein the method further comprises:
monitoring usages of the shareable vehicles in the preset area;
reducing the number of the shareable vehicles allocated in the preset area when the number of the shareable vehicle is greater than a first predetermined number in the preset area; and
increasing a preset number of shareable vehicles in the preset area when the number of the shareable vehicle is less than a second predetermined number in the preset area.

13. The non-transitory storage medium according to claim 12, wherein the method further comprises:
calculating a ratio α between the total number of passengers needing to travel with short-distance and the actual number of passengers using the shareable vehicle according to an increased number of shareable vehicles or a reduced number of shareable vehicles;
calculating the number of shareable vehicles needing to be allocated in the preset area according to formula: y=x/α, wherein x is the total number of passengers needing to travel with short-distance; and
allocating the number of shareable vehicles in the preset area according to the calculated number of shareable vehicles.

14. The non-transitory storage medium according to claim 11, wherein the method further comprises:
determining whether a travel distance of the passenger is less than or equal to a predetermined distance according to the travel route of each of the at least one passenger;
determining that the passenger needs to travel with short-distance in the preset area when the travel distance of the passenger is less than or equal to the predetermined distance.

15. The non-transitory storage medium according to claim 11, wherein the method further comprises:
collecting at least one first facial image of the at least one passenger when the at least one passenger is getting on the bus at a first bus stop;
collecting at least one second facial image of the at least one passenger when the at least one passenger is getting off the bus at a second bus stop; and
determining the travel route of each of the at least one passenger according to the first facial image and the second facial image, and a route from the first bus stop to the second bus stop.
